(19) United States
(12) Patent Application Publication
(10) Pub. No.: US 2010/0326952 A1
(43) Pub. Date: Dec. 30, 2010

(54) METHOD AND MEANS FOR IDENTIFYING BOTTLED WINE

(76) Inventor: Michael J. Corliss, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/494,128

(22) Filed: Jun. 29, 2009

(51) Int. Cl. B65D 25/00; B32B 38/14

(52) U.S. Cl. 215/386; 156/277

(57) ABSTRACT

A method of identifying bottled wine before it is labeled includes the steps of selecting a glue of a particular color and heating it to a fluid consistency. An amount of warm glue is placed on the bottom surface of the wine bottle and allowed to cool such that it adheres to the bottom surface to form an identifying mark. Prior to cooling, the glue may be stamped with an embossed seal to imprint it with various information such as the identity of the manufacturer and the vintage year. The color of the glue is selected to relate to and identify a particular type of wine.

### BACKGROUND

This invention relates to a method and apparatus for identifying bottled wine before it is labeled. Many wines, particularly those of high quality, are bottled and aged after they are made, often for a number of years. Traditionally, such storage takes place in cellars, thus the term “cellaring” came into use, even though, in most modern production, the wine is aged in temperature-controlled wine storage areas. Actual labeling of bottles typically does not occur until shortly before the wine is to be released for sale in order to protect the appearance of the label from deterioration during the years of cellaring.

A problem has existed with respect to the identification of such unlabeled bottles. Typically, the racks in which the wine is stored are marked to identify the vintage and type of wine in the bottles; however, the possibility of such a mark becoming detached or particular bottles being moved and not replaced in the same rack, presents the likelihood of confusion arising between bottles of Merlot, Cabernet, or other wines in bottles of like shape.

The present invention provides a novel way of identifying both the type of wine and its vintage year on a bottle-by-bottle basis. In addition, the identification mark may provide a unique commercial advantage even after the wine is labeled as well as making it more difficult for wine counterfeiters to sell low priced wine as high priced wine. This is typically done by forging high priced wine labels and placing them on low priced wine. Use of the present invention as described below would require a counterfeiter to take a second, much more costly step, in order to fraudulently replicate a high priced wine.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An identifying mark is placed on the bottom of each bottle of wine to be stored for aging. In a preferred form of the present invention, the mark comprises a colored seal positioned on the bottom of each bottle. The color of the seal is chosen to correspond to a particular type of wine such that all bottles of Cabernet, for example, may bear a red seal, while bottles of Merlot may bear a blue or other color seal.

The seal is formed by selecting a glue of a particular color, heating it, and then depositing an appropriate amount onto the bottom of each wine bottle and allowing it to cool and adhere to the bottom surface. Before cooling, the colored glue may be stamped with indicia such as the vintage year, the identity of the maker of the wine, or any other helpful information. Since most bottles of quality wine include a concave bottom surface called a “punt,” the glue seals are well protected against dislodgement by contact with other bottles or the rack on which the bottles are stored during aging. The present invention thus provides a reliable means for identifying an unlabeled bottle of wine during years of aging in order to prevent confusion as to the type and vintage of wine in the bottle.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an elevation view of a wine bottle with a portion of the side of the bottle cut away to show a seal positioned on the bottom of the bottle;

FIG. 2 is a bottom perspective view of a wine bottle showing a glue seal positioned on the bottom of the bottle;

FIG. 3 is a perspective view of one method of depositing seal material flowing from a heating machine onto the bottom of a wine bottle;

FIG. 4 is a bottom view of a wine bottle including a seal bearing indicia including a vintage year and an identification mark; and

FIG. 5 is an elevation view of a wine storage rack showing identification marks made according to the present invention positioned on the bottom of a plurality of wine bottles.

### DETAILED DESCRIPTION

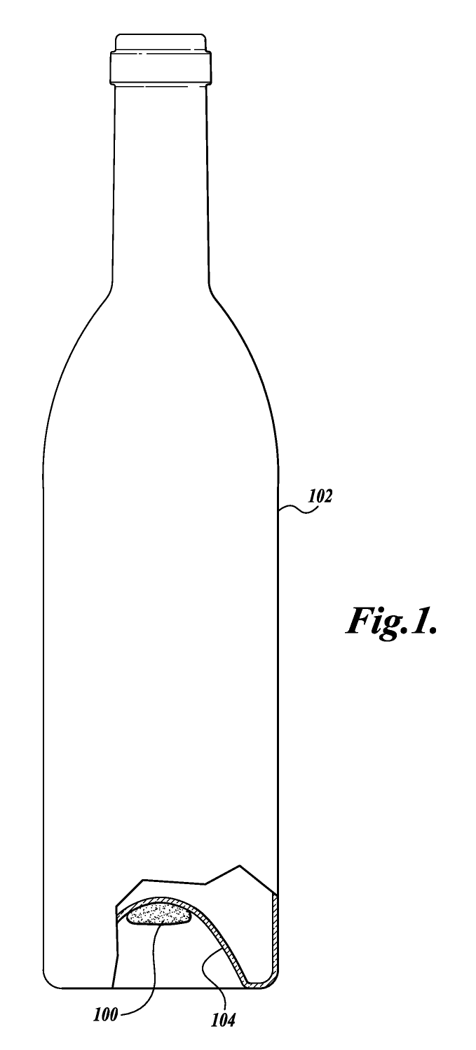

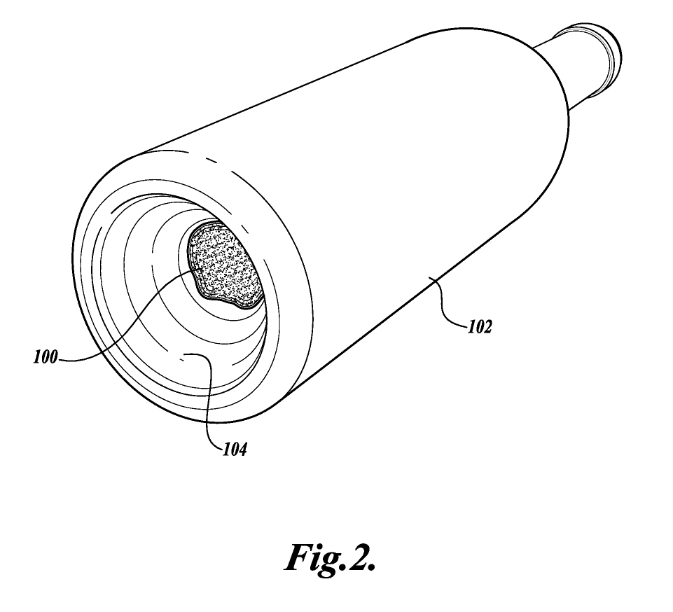

FIGS. 1 and 2 show a first exemplary embodiment of a seal marker 100 positioned on the bottom of a conventional wine bottle 102. As will be described in more detail hereafter, the seal 100 is positioned on the bottom of a wine bottle by flowing heated material such as glue onto the bottom of the bottle. As such, it will be understood that the particular peripheral shape of the marking material positioned on the bottom of the wine bottle will vary for each bottle and, thus, the size and shape of the markers disclosed in the drawings are exemplary and should not be considered limiting. In other embodiments of the present invention, a preformed disk of a particular shape may be adhered to the bottom of the bottle as an identification means, but in the preferred embodiment, warm material such as a colored glue is simply flowed into the bottom and allowed to cool and adhere thereto.

Bottle 102 is shown to include a concave bottom 104. Such a concave surface is called a “punt” and is typically used to strengthen the bottom of a bottle of the type used for wines of high quality which are intended to be aged for a substantial period of time. Such a recessed cavity provides an ideal place to mark a wine bottle for identification since the likelihood of the marker being dislodged as a result of contact with other stored wine bottles, their storage rack, or anything else is small. Since the punt includes a relatively small curved bottom portion, it has been found that flowing liquid material into the punt allows it to conform to the bottom surface of the punt in a manner which is simpler than trying to attach a preformed seal mechanically, such as by gluing.

Seal 100 is preferably formed of a glue-type material such as Custom Color General Purpose Glue Sticks manufactured by Merchant-General Corporation of Oldsmar, Fla. This material comes in stick form and when placed in a conventional hot glue machine and heated, will flow.

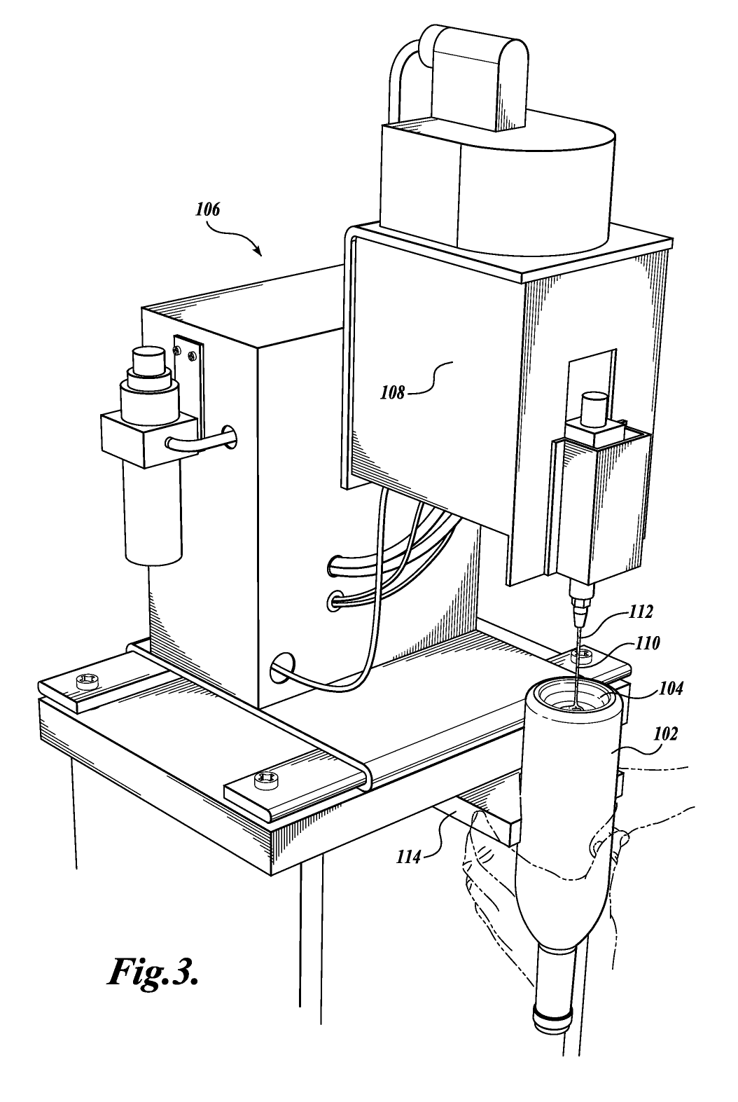

Referring to FIG. 3, a conventional hot glue machine 106 of the type manufactured by HES and sold under Model No. HS0753-11 is disclosed. Sticks of glue inserted into the top of the machine are heated and softened in glue reservoir 108 such that the glue may flow in a stream 110 out of nozzle 112.

When it is desired to mark a bottle 102, the bottle is inverted and slipped into a jig 114 which makes it easy to hold the bottle steadily during the period when the glue is allowed to flow into the concave bottom of the bottle 104. It will be understood that this process may also be carried out as part of an automated bottling line. The amount of glue delivered may be automatically controlled or controlled by an operator so that a relatively uniform amount is disposed in the bottom of each bottle. The jig also helps maintain the location at which the glue is deposited such that the finished marker seals have a relatively uniform size and location.

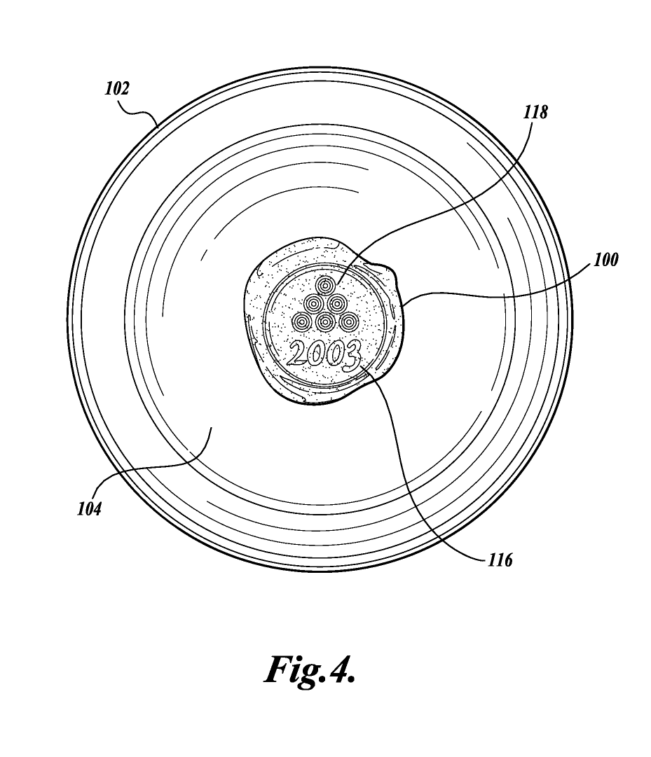

After an appropriate amount of glue is deposited in the bottom of the wine bottle, the bottle may be set aside in a rack or the like and allowed to cool. Referring additionally to FIG. 4, once the glue has hardened to the point where it can receive an impression and hold it, it may be stamped to mark the seal with such information as the vintage year, exemplarily illustrated as the year 2003 in FIG. 4 at 116. In addition, the stamp may include other identification indicia such as the trademark shown at 118 which, again, is illustrative only. It will be understood that various types of information may be stamped into the glue seal as is desired by the winemaker.

A feature of the present invention is the ability to use glues of differing color for wines made of different varieties of grapes. Thus, it will be understood that for a Cabernet wine, a particular color of glue can be selected and used uniformly and only on bottles of wine made from Cabernet grapes. Likewise, for Merlot, a different color glue would be selected and used to identify all bottles of wine made from Merlot grapes. Other colors would be selected for other types of wine or blends of different wine, so that even without the bottle being labeled, one may identify the contents of a bottle of wine simply by looking at the color of the glue seal marker.

It is contemplated that the glue seals would typically be stamped by hand using a conventional embossed metal stamp, although it will be understood that for large production runs, the entire process of depositing a specific amount of colored glue in the punt of a wine bottle, allowing it to cool to a temperature where it will receive and hold an impression, and then stamping it, may all be carried out by machine in a conventional manner. It is also contemplated that the glue may be allowed to cool and harden and that the stamping be done using a heated embossed stamp.

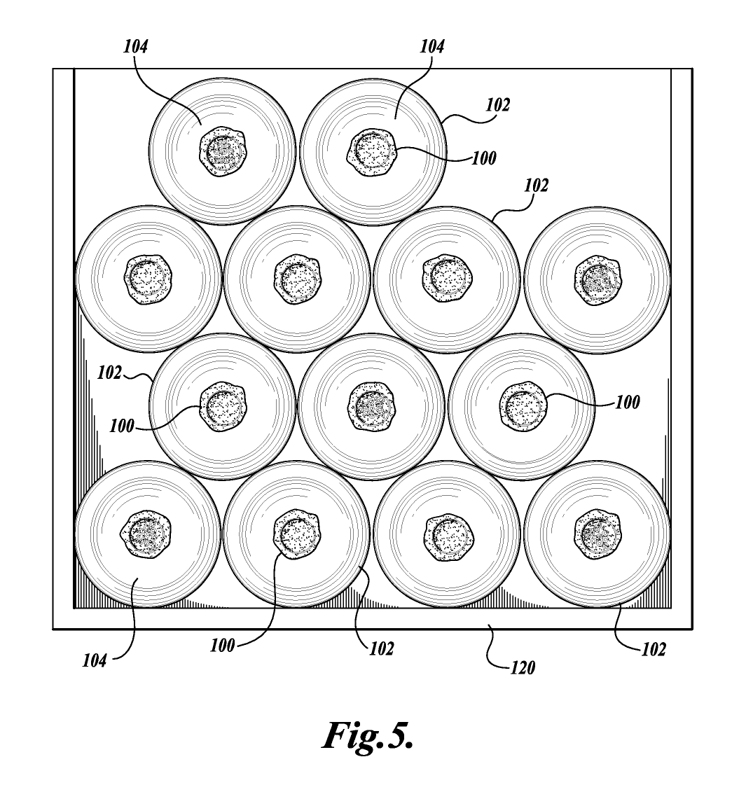

Turning to FIG. 5, a stack of wine bottles 102 are shown lying in a rack 120 for storage. Wines are aged by storing on their sides such that wine remains in contact with the cork to prevent the cork from drying out and allowing air to come into contact with the wine. Glue seals 100 are shown in the punts 104. It will be understood that for drawing convenience, not all of the bottles are shown to bear vintage or trademark information but that in actual use, all of the stamps would be marked as desired by the winemaker. It will thus be understood that the present invention provides a method and means for marking a filled wine bottle during storage before it is labeled in a manner in which the marker is not likely to become dislodged during storage. The correspondence of the colors of the glue seals to the type of wine contained in the bottle provides a near foolproof way for preventing confusion as to the type of wine within the bottle, even though the wine may be stored for a number of years. In addition, marking the glue seals with the vintage year prevents like-types of wine from different years being confused with each other. It is also contemplated that the glue color might be selected to identify a vintage year and the type of wine embossed into the glue seal marker.

Shortly prior to the release of the wine after it has completed aging, the bottles are removed from storage and paper labeled in a conventional manner. After the wine is sold, it is often displayed in wine stores in horizontal racks to, again, prevent the cork from drying out. The unique marking of the bottoms of the wine bottles with the wax seals presents an easy way for consumers to identify the winemaker's wine and differentiate it from the wines of other winemakers, as well as to differentiate authentic wine from wine bearing counterfeit paper labels. The placement of a trademark or other identifying indicia on the glue seal assists in this process, but the use of wax seals alone acts as a unique identifying feature for the wines which is visible from a distance where the particular form of a trademark on the seal may not be discernible.

While illustrative embodiments have been shown and described, it will be appreciated that various changes can be made therein without departing from the spirit and scope of the present invention.

The embodiments of the invention in which an exclusive property or privilege is claimed are defined as follows:

1. A method of identifying bottled wine comprising the steps of:
selecting a glue of a particular color;
heating the glue to a fluid consistency;
flowing an amount of glue onto the bottom surface of a wine bottle to cover a portion of said bottom surface; and
allowing the glue to cool such that it adheres to said bottom surface to form an identifying seal marker.

2. The method of claim 1 including the step of storing said wine for aging, said storing including the step of laying said bottle on its side such that the identifying seal marker is visible.

3. The method of claim 1 including the steps of storing a plurality of wine bottles filled with the same type of wine;
selecting a glue of a particular color for use with said same type of wine; and
storing said similarly marked bottles adjacent to each other such that the marked bottoms of said wine bottles are visible.

4. The method of claim 1 including the step of selecting a wine bottle having a concave bottom.

5. The method of claim 1 including the step of selecting particular colors of glue to correspond to particular varieties of wine such that the type of wine in a bottle may be identified by viewing the color of the identifying seal marker on the bottom of a bottle of wine.

6. The method of claim 1 including the step of stamping the seal marker on the bottom surface of a wine bottle to imprint the glue with identifying indicia.

7. The method of claim 6 wherein the glue is stamped to imprint indicia identifying the maker of the wine.

8. The method of claim 6 wherein the indicia marked on the glue identifies the vintage year of the wine.

9. The method of claim 6 wherein the indicia imprinted into the seal marker identifies both the maker and the vintage of the wine in the bottle and wherein the color of the seal marker identifies the type of wine within the bottle.

10. The method of claim 1 including the step of stamping the glue with an embossed metal stamp before the glue hardens such that the stamped glue has the appearance of a stamped wax seal.

11. A method of identifying unlabeled wine bottles comprising the steps of:
adhering a colored marker on the bottom of a wine bottle;
selecting the color of the marker to correspond to a particular variety of wine; and
using said particular colored marker only in connection with said particular type of wine.

12. An identifying marker for a wine bottle comprising a colored seal adapted to be adhered to the bottom of a wine bottle, the color of said seal marker being selected to identify a particular type of wine.

13. The identifying marker of claim 12 wherein said marker is formed of a colored glue.

14. The identifying marker of claim 13 wherein the glue is poured onto the bottom of said bottle while in a liquid state and then allowed to cool.

15. The identifying marker of claim 12, wherein said colored seal includes identifying information imprinted thereon.

16. An identifying marker for a wine bottle comprising a glue seal marker adhered in the bottom of a wine bottle, said seal being marked with indicia identifying the wine in the bottle.
